(19) United States
(12) Patent Application Publication
(10) Pub. No.: US 2010/0044610 A1
(43) Pub. Date: Feb. 25, 2010

(54) DEVICE FOR OPENING AND CLOSING OUTLETS OF A FLUID DISTRIBUTOR VALVE

(75) Inventor: Marc Badosa Carbones, Sant Jaume de Llierca (ES)

Correspondence Address: MERCHANT & GOULD PC, P.O. BOX 2903, MINNEAPOLIS, MN, 55402-0903, US

(73) Assignee: Sacopa, S.A.U., Sant Jaume de Llierca (ES)

(21) Appl. No.: 12/538,452

(22) Filed: Aug. 10, 2009

(30) Foreign Application Priority Data
Aug. 20, 2008 (ES) 200802465 P

(51) Int. Cl. F16K 31/44

(52) U.S. Cl. 251/248; 251/250.5

(57) ABSTRACT

A device for opening and closing outlets of a fluid distributor valve includes a body having outlets, and a bonnet housing a rotor submitted to the action of the inflowing fluid and connected to a reducing gear activating the closing device. The opening of the outlets is carried out with respective angularly sliding shutters being turned by successively shifting them in opposite directions to respectively obtain the opening and closing of the outlets. The rotation of the bonnets is determined by lugs below a base bushing bearing, the reducing gear operating on lugs fitted onto the edge of the bonnets.

This application claims benefit of Serial No. 200802465 P, filed 20 Aug. 2008 in Spain and which application is incorporated herein by reference. To the extent appropriate, a claim of priority is made to the above disclosed application.

### OBJECT OF THE INVENTION

A device for opening and closing outlets of a fluid distributor valve.

### FIELD OF THE INVENTION

This device is preferably applied in connection with swimming pool bottom cleaning systems which direct pressurised water to dispersal nozzles strategically located at the bottom of the pool.

### BACKGROUND TO THE INVENTION

Distributor valves are already known and comprise a chamber being made up between a body and a bonnet, said body having a water inlet port and several water outlets comprising closure and opening members being actuated by means of a reducing gear acting by virtue of the action of the inflowing water on a rotor cooperating with said gear.

In these devices the opening and closing of the fluid outlets generally comprise moving bonnets that are articulated or sliding.

### SUMMARY OF THE INVENTION

The purpose of this invention is to improve this form of device with new bonnets fitted so that they do not suffer wear from the friction of the movements using simplified methods for its operation. This wear means that there is low load losses.

The feature of this device is the fact that the opening and closing of the water outlets is performed by rotating circular bonnets on a vertical axle fitted with openings that are operated by methods acting on its edge determining its partial rotation.

The means determining the rotation of the bonnets comprise lugs below a base bushing bearing the reducing gear operating on lugs fitted onto the edge of the bonnets.

The bonnets are conical and rest on circular bearing bases vertical with the rotating axle that are also conical with openings, with these circular bases occupying the outlets.

These and other characterising features will be best made apparent by the following detailed description whose understanding will be made easier by the accompanying sheet of drawings showing a practical embodiment being cited only by way of example not limiting the scope of the present invention.

### DESCRIPTION OF THE DRAWINGS

In the drawings:

FIG. 1 is a perspective view of the body of the valve comprising the device in this invention,

FIG. 2 is a perspective view of the rotating bonnet, and

FIG. 3 shows a perspective of the base bushings operating on the bonnets.

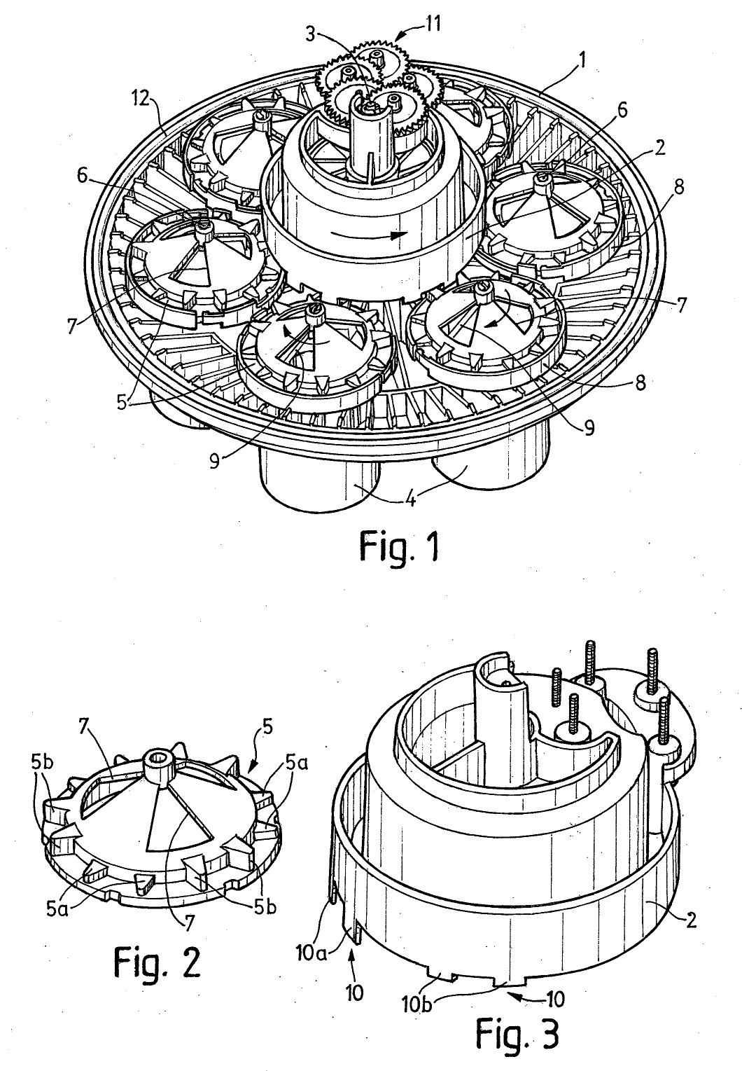

### DESCRIPTION OF THE PREFERRED EMBODIMENT

According to the drawings the device in this invention applies to a distribution valve comprising the circular body (1) in the centre of which there is the base rotating bushing (2) on a vertical axle (3) in which there is also a roller (not visible) driven by the action of the water that enters the valve via a lower opening centrally located in the body (1). Around the said opening there are holes with a tubular outlet (4) that are blocked by seals comprising rotating circular bonnet (5) on a vertical axle (6) and fitted with radial and angular openings (7), the bonnet of which are conical and rest on circular bearing bases (8) on the aforementioned axle (6) and which are also conical with opening (9), with these bases occupying the outlets.

These bonnets (5) are rotated by means that make them partially rotate to obtain the opening or closing of the outlets, the methods of which comprise lower lugs (10) (FIG. 3) on the base bearing bushing (2) for the reducing gear (11) that operate on the lugs fitted onto the edge of the bonnets (5).

The lugs of the base bushing (2) comprise two pairs (10a) and (10b) of different heights and the bonnet lugs (5) comprise several pairs (5a) and (5b) also at different heights.

The operation of the upper lugs (10a) on the base bushing (2) push the lower lugs (5a) on the bonnet (5) closing it and the lower lugs (10b) on the base bushing push the upper lugs (5b) on the bonnet.

The difference in height of the aforementioned lugs has been planned to impede the incorrect fitting of the bonnets that may affect the proper operation of the valve. In this embodiment, if the bonnets are fitted in any manner it will mean that they will work properly.

Reference (12) indicates the O-ring joint designed for the sealed coupling of the bonnet (not shown) comprising a pressure gauge and a purge outlet with a screw-in lid.

1. A device for opening and closing outlets of a fluid distributor valve, wherein said fluid distributor valve comprises a body having outlets, and a bonnet housing a rotor submitted to the action of inflowing fluid and connected to a reducing gear activating the opening and closing device;
respective angularly sliding shutters turned by successively shifting the shutters in opposite directions to respectively open and close said outlets.

2. A device for opening and closing outlets of a fluid distributor valve, according to claim 1, wherein means determining rotation of the bonnets comprise lugs below a base bushing bearing the reducing gear operating on lugs fitted onto the edge of the bonnets.

3. A device for opening and closing outlets of a fluid distributor valve, according to claim 2, wherein the lugs on the base bushing and lugs on the bonnets are at different heights.

4. A device for opening and closing outlets of a fluid distributor valve, according to claim 1, wherein the bonnets are conical and rest on circular bearing bases vertical with the rotating axle that are conical with openings, wherein the circular bases occupy the outlets.
